(19) United States
(12) Patent Application Publication
(10) Pub. No.: US 2007/0110925 A1
(43) Pub. Date: May 17, 2007

(54) GRAPHICS SUBSTRATE

(75) Inventor: Hank Brian Ridless, Boulder, CO (US)

Correspondence Address: ADAMS EVANS P.A., 201 SOUTH COLLEGE STREET, SUITE 2350, CHARLOTTE, NC, 28244, US

(73) Assignee: Circle Graphics, LLC, Longmont, CO (US)

(21) Appl. No.: 11/382,156

(22) Filed: May 8, 2006

Related U.S. Application Data
(60) Provisional application No. 60/597,160, filed on Nov. 14, 2005.

(51) Int. Cl. B32B 27/12; B41M 5/00

(52) U.S. Cl. 428/32.16; 428/196; 442/286; 442/394

(57) ABSTRACT

A graphics substrate includes: a core layer having opposed front and back sides, and a polymeric top layer bonded to the front side of the core layer. The top layer defines a front face which is receptive to solvent-based inks. In one aspect, the top layer and the core layer are adapted to be recycled without first being separated. In another aspect, a unit weight of the substrate is about 270 g/m² or less. The substrate may be carried on a support to provide a graphics display. A method of making the substrate includes: providing a core layer having opposed front and back sides, and bonding a polymeric top layer to the front side of the core layer.

### CROSS-REFERENCE TO RELATED APPLICATIONS

This application claims the benefit of Provisional Application Ser. No. 60/597,160, filed on Nov. 14, 2005.

### BACKGROUND OF THE INVENTION

This invention relates generally to advertising displays, and more particularly to a graphics substrate suitable for outdoor advertisements.

Large graphics substrates are used in many applications such as billboards, banners, temporary signs, theater backdrops, tents and awnings, and the like. To provide adequate durability and weather resistance, and sufficient tensile strength to be used with mounting systems that employ mechanical fasteners or clamps, graphics substrates are being produced from polymers instead of traditional paper materials.

However, existing polymer-based graphics substrates are relatively heavy, e.g., about 407 g/m² (12 oz./yd.²), which makes them inconvenient to install and increases their cost. Furthermore, the most commonly used types of polymeric graphics substrates are made of combinations of different materials that are not readily recyclable.

### BRIEF SUMMARY OF THE INVENTION

Accordingly, it is an object of the invention to provide a strong, lightweight graphics substrate.

It is another object of the invention to provide a graphics substrate that can be easily recycled.

These and other objects are met by the present invention, which according to one aspect provides a graphics substrate, including: a core layer having opposed front and back sides; and a polymeric top layer bonded to the front side of the core layer, the top layer defining a front face which is receptive to solvent-based inks; wherein a unit weight of the substrate is about 270 g/m² or less.

According to another aspect of the invention, a unit weight of the substrate is about 203 g/m² or less.

According to another aspect of the invention, the top layer is substantially opaque.

According to another aspect of the invention, the core layer and the top layer are selected such that the substrate may be recycled without prior separation of the layers.

According to another aspect of the invention, the core layer and the top layer both comprise polyolefins.

According to another aspect of the invention, the core layer consists essentially of woven polypropylene.

According to another aspect of the invention, the core layer consists essentially of woven polyethylene sheet.

According to another aspect of the invention, the core layer consists essentially of non-woven polypropylene.

According to another aspect of the invention, the top layer consists essentially of polypropylene.

According to another aspect of the invention, the front face is defined by a print-receptive coating applied to the top layer.

According to another aspect of the invention, a tying layer effective to bond the top layer and the core layer together is disposed therebetween.

According to another aspect of the invention, a backing layer is bonded to the back side of the core layer.

According to another aspect of the invention, the graphics substrate further includes a tying layer effective to bond the backing layer and the core layer together disposed therebetween.

According to another aspect of the invention, the core layer is black.

According to another aspect of the invention, the backing layer is black.

According to another aspect of the invention, a graphics substrate includes: a core layer having opposed front and back sides; and a polymeric top layer bonded to the front side of the core layer, the top layer defining a front face which is receptive to solvent-based inks; wherein the top layer and the core layer are adapted to be recycled without first being separated.

According to another aspect of the invention, a method of making a graphics substrate includes: providing a core layer having opposed front and back sides; and bonding a polymeric top layer to the front side of the core layer, the top layer defining a front face which is receptive to solvent-based inks; wherein the top layer and the core layer are adapted to be recycled without first being separated.

According to another aspect of the invention, the top layer is bonded to the core layer by the steps of: extruding a polymeric top layer onto the front side of the core layer in a fluid state; and allowing the top layer to solidify.

According to another aspect of the invention, the top layer is bonded to the core layer by a lamination process comprising: heating the top layer; pressing the top layer onto the front side of the core layer; and allowing the top layer to bond to the core layer.

According to another aspect of the invention, the top layer is bonded to the core layer by a lamination process comprising: disposing a tying layer between the top layer and core layer; pressing the top layer to the front side of the core layer; and allowing the top layer to bond to the core layer.

According to another aspect of the invention, the core layer and the top layer are co-extruded in a fluid state and then allowed to solidify.

According to another aspect of the invention, the front face includes a coating receptive to solvent-based inks.

According to another aspect of the invention, the method further includes: subjecting the front face to a treatment effective to increase its surface energy; and applying a coating receptive to solvent-based inks to the front face.

According to another aspect of the invention, the coating comprises an acrylic material.

According to another aspect of the invention, a unit weight of the substrate is about 270 g/m² or less.

According to another aspect of the invention, a unit weight of the substrate is about 203 g/m² or less.

According to another aspect of the invention, a tying layer effective to bond the top layer and the core layer together is disposed therebetween prior to bonding of the core layer to the top layer.

According to another aspect of the invention, the method further includes bonding a backing layer to the back side of the core layer.

According to another aspect of the invention, a tying layer effective to bond the backing layer and the core layer together is disposed therebetween prior to bonding of the backing layer to the core layer.

According to another aspect of the invention, a graphics display includes: a support; and a graphic substrate carried by the support, the substrate including: a core layer having opposed front and back sides; a polymeric top layer bonded to the front side of the core layer, the top layer defining an exposed front face which is receptive to solvent-based inks; and graphics printed on the front face; wherein the core layer and the top layer are selected such that the substrate may be recycled without prior separation of the layers.

According to another aspect of the invention, the product is substantially opaque.

According to another aspect of the invention, a unit weight of the substrate is about 270 g/m² or less.

According to another aspect of the invention, a unit weight of the substrate is about 203 g/m² or less.

According to another aspect of the invention, the support is a billboard.

### BRIEF DESCRIPTION OF THE DRAWINGS

The invention may be best understood by reference to the following description taken in conjunction with the accompanying drawing figures in which:

FIG. 1 is a perspective view of a graphics substrate constructed according to the present invention; and

FIG. 2 is a cross-sectional view of a portion of the substrate of FIG. 1.

### DETAILED DESCRIPTION OF THE INVENTION

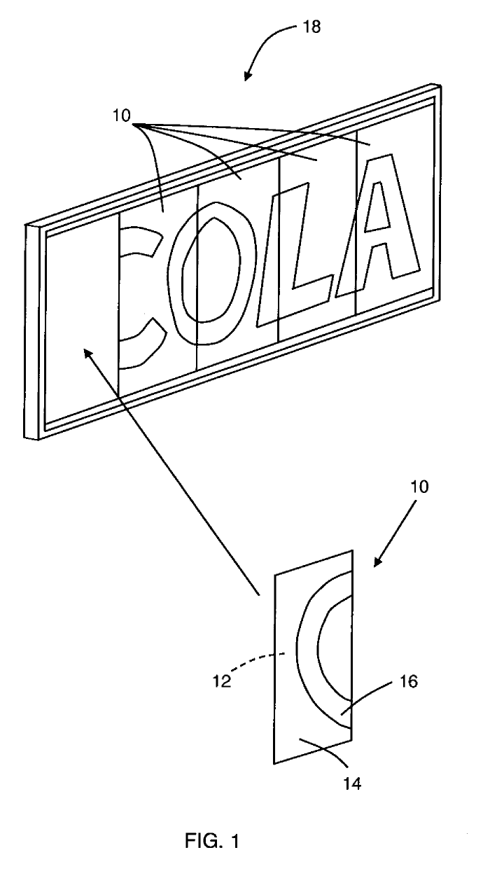

Referring to the drawings wherein identical reference numerals denote the same elements throughout the various views, FIG. 1 illustrates an exemplary graphics substrate 10 constructed according to the present invention. The substrate is a flexible, sheet-like material with a back face 12 and an opposing front face 14. Graphics 16 are disposed on the front face 14, for example by printing. In the illustrated example, the substrate 10 is attached to a conventional billboard 18 for use as an outdoor display. However, the substrate 10 may be used for any application in which a printable material is needed, such as banners, temporary signs, flags, temporary signs, theater backdrops, tents and awnings, etc.

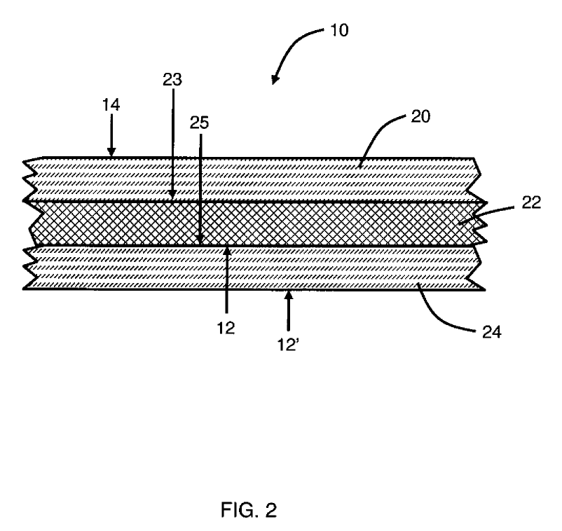

As shown in FIG. 2, the substrate 10 is a laminar structure having a top layer 20 which defines the front face 14, bonded to a core layer 22 having a front side 23, and an opposed back side 25 which defines the back face 12. Optionally, a backing layer 24, similar or identical in composition to the top layer 20, may be applied to the core layer 22 opposite the top layer 20. The backing layer 24 may be used to provide a printable surface or merely to provide a smooth appearance. It may also be black or another dark color to enhance opacity. If used, the backing layer 24 defines the back face 12′. While the composition and structure of the substrate 10 may vary, its key properties are that it be “printable” or “print-receptive” (i.e. that it will receive and hold inks or dyes applied thereto, for example solvent-based inks as used in known inkjet printing processes), resistant to creasing, and relatively light weight, for comparable uses. For example, in a billboard application it may weigh less than about 203 g/m² (6.0 oz./yd.²), possibly less than 136 g/m² (4.0 oz./yd.²); for applications such as truck-mounted signage, the weight would be greater but still generally less than about 270 g/m² (8.0 oz./yd.²). The ultimate tensile strength should be about 36 kg (80 lbs.) or greater in each direction, for a 2.5 cm (1 in.) wide strip. The substrate 10 should also be substantially opaque so that any printing thereon is clearly readable. Within the printing field, a level of opacity of about 95% or greater would be considered “opaque” for practical purposes.

The top layer 20 is a polymer which provides a smooth, print-receptive surface when coated. A wide variety of polymers may be used, for example polypropylene (PP), biaxially-oriented polypropylene (BOPP), polyethylene terephalate (PET), polyvinyl chloride (PVC), and polyethylene (PE). Preferably the polymer used is less dense than PVC, and generally polypropylene (PP) and polypropylene-based materials have been found preferable. A blend of polypropylene with about 15% to about 30%, and preferably about 5% to about 25% by weight of polyethylene has been found to be especially suitable. The top layer 20 may be produced by casting, molding, extrusion, film blowing, or similar methods. The thickness of the top layer 20 should be the minimum required to produce a smooth surface. In the illustrated example, the top layer 20 is about 0.01 mm (0.4 mils) to about 0.05 mm (2.0 mils), preferably about 0.03 mm (1.0 mils) to about 0.05 mm (2.0 mils) thick. Oriented polypropylene films which are suitable for use as the top layer 20 are available from Applied Extrusion Technologies, New Castle, Del., 19720 USA.

In addition to the base polymer or polymers, the top layer 20 may include various additives to improve suitability for various applications. Examples of specific additives include pigments such as titanium dioxide for color and opacity, fire retardants such as aluminum hydroxide, UV inhibitors, and additives such as metallocene or elastomers for flexibility.

While polypropylene and its blends thereof offer good strength at light weights, they are not readily printable as manufactured. Therefore, the front face 14 is provided with a treatment, coating, or a combination thereof to make it printable. One suitable manner in which this may be done is to subject the front face 14 to a corona treatment or other treatment to increase its surface energy, and then topcoat the front face 14 with an acrylic coating receptive to solvent-based inks.

The core layer 22 provides the majority of the mechanical strength of the substrate 10. The core layer 22 should be lightweight, readily able to bond to the top layer 20, and have good tensile strength Virtually any strong, flexible, sheet-like material may be used for the core layer 22. Non-limiting examples of suitable materials include polymer sheet, fiberboard, woven natural or synthetic fabrics, metallic fabrics, and glass fibers. If the core layer 22 is made from a material with a similar composition to the top layer 20, for example a polyolefin, this will facilitate recycling of the entire substrate 10. Specifically, this will make it possible to recycle the substrate 10 without first separating the core layer 22, top layer 20, and backing layer 24 (if used). Cast, extruded, spunbond, nonwoven, or woven polymer fabrics may be used this purpose. The core layer may be black or another dark color to enhance opacity.

One suitable material is a 100% polypropylene nonwoven fabric sold under the trade name TYPAR. Another especially suitable material for the core layer 22 is a woven polypropylene sheet, which may be made, for example, by providing an extruded cast polypropylene film, which is heated, stretched, and then cut into narrow fibers or “tapes” which are subsequently woven into a sheet. Such a material is used in the prior art for making storage sacks and the like. Another suitable material is woven polyethylene. In addition to the base polymer or polymers, the core layer 22 may include various additives to improve suitability for various applications. Examples of specific additives include pigments such as titanium dioxide for color and opacity, fire retardants such as aluminum hydroxide, UV inhibitors, and additives such as metallocene or elastomers for flexibility.

The top layer 20 may be joined to the core layer 22 in a number of ways, and the exact method of construction is not critical. For example, the top layer 20 may be extruded in a fluid state onto the core layer 22. The top layer 20 could also be “laminated” to the core layer 22, i.e. provided as a sheet, and then pressed onto the core layer 22. If necessary, a tying layer such as adhesive may be interposed between the top layer 20 and the core layer 22. Finally, depending on the characteristics of the core layer 22, the top layer 20 and the core layer 22 could be co-extruded simultaneously.

The dimensions of the substrate 10 are limited only by the size of the production equipment. For example, a substrate 10 could be laminated at approximately 5 m (200 in.) wide for use as a banner or billboard material. A final product could also be made by producing sections of substrate 10 and then attaching them together, for example using adhesives, sonic welding, thermal welding, fastening, crimping, or the like.

### EXAMPLE 1

A graphics substrate 10 was constructed with a polypropylene-based top layer 20 about 0.04 mm (0.0015 in.) thick with the following approximate composition by weight: about 65% polypropylene, about 15% elastomer, about 10% polyethylene; and about 10% of an additive package. The polyethylene used was VORIDIAN 808P polyethylene, available from Eastman Chemical Company, Kingsport, Tenn., 37660 USA, The elastomer used was a copolymer of ethylene vinyl acetate and vinyl acetate, SCC code 05SAM0553, available from Standridge Color Corp., Social Circle, Ga., 30025 USA. The additive package, also available under SCC code 05SAM1033 from Standridge Color Corp., comprised, by weight, about 10% of a fire retardant, about 5% phenol 2-2-H-Benzotriazol-2-Y-4,6 Bis1, about 36.4% titanium dioxide, and about 49% stabilizers. The top layer 20 was extrusion coated to a core layer 22 comprising a woven 100% polypropylene fabric approximately 0.2 mm (0.0075 in.) thick having a plain weave of about 8 threads per cm² in each direction and weighing about 95 g/m² (2.8 oz./yd.²).

The finished material was white, opaque, and had a weight per unit area of about 156 g/m² (4.6 oz./yd.²). The finished substrate could be coated as described above to make it readily printable using standard solvent-based inkjet printers.

The substrate 10 of example 1 was tested for various physical properties. The results are listed in the following Table 1. It is noted that the tensile strength measurements are based on a grab test of a 7.6 cm (3-in.) wide sample.

TABLE 1

| Average Tensile | Average Tensile | Average | Average | Fabric Trap | Fabric Trap | | |
|---|---|---|---|---|---|---|---|
| Strength (lbs.) | Strength (lbs.) | Elongation (%) | Elongation (%) | Tear (lbs.) | Tear (lbs.) | Puncture | Mullen Burst |
| Warp | Fill | Warp | Fill | Warp | Fill | (lbs.) | (psi) |
| 203 | 142 | 14 | 14 | 60 | 32 | 65 | 290 |

The completed graphics substrate 10 as described above has several desirable properties. It has a low total weight per unit area, and accordingly a low unit cost. It is strong, flexible, and weather resistant. Furthermore, because the entire substrate 10 is made from polyolefins, it can be easily recycled without complex separation steps.

### EXAMPLE 2

A graphics substrate was constructed with a BOPP top layer about 0.02 mm (0.9 mils) thick. A core layer was provided comprising a 24×18 woven 100% polypropylene, black, nonlubricated fabric, weighing about 109 g/m² (3.2 oz./yd.²). After corona treatment of the mating surfaces, the top layer was laminated to the core layer using an intermediate solvent-based adhesive layer sold as ADCOTE, available from Rohm & Haas, West Philadelphia Pa. 19106. The front face of the top layer was corona treated and then an acrylic print coating was applied thereto. A print coating including calcium carbonate was found to provide good color intensity when used with solvent-based inks. The finished product had a weight of about 170 g/m² (5 oz./yd.²)

### EXAMPLE 3

A graphics substrate is constructed by bonding an oriented polypropylene top layer approximately 0.02 mm (0.9 mils) thick weighing approximately 20 g/m² (0.58 oz/yd.²) to a core layer of woven 24×11 polypropylene weighing approximately 109 g/m² (3.2 oz/yd.²). The total weight of the substrate constructed in this manner (including print coating and adhesive) is about 156 g/m² (4.6 oz/yd.²). The substrate has a tensile strength (to failure) of about 52 kg (115 lbs.) per 2.5 cm (1 in.) width in the machine (warp) direction and about 42 kg (92 lbs.) per 2.5 cm (1 in.) width in the cross (fill) direction.

### EXAMPLE 4

A graphics substrate is constructed by bonding an oriented polypropylene top layer approximately 0.02 mm (0.9 mils) weighing approximately 20 g/m² (0.58 oz/yd.²) to a core layer of woven 7×6 polypropylene weighing about 81 g/m² (2.4 oz/yd.²⁾. The core layer would include an extrusion coated layer of polypropylene on its backside to create a smooth backside surface on the finished product. A print coating is applied to the top layer as described above. The total weight of the substrate constructed in this manner is about 139 g/m² (3.8 oz/yd.²). The substrate has a tensile strength (to failure) of approximately 64 kg (140 lbs.) per 2.5 cm (1 in.) in the machine (warp) direction and 59 kg (130 lbs.) per 2.5 cm (1 in.) in the cross (fill) direction.

The foregoing has described a graphics substrate and a method for its production. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A graphics substrate, comprising:
a core layer having opposed front and back sides; and
a polymeric top layer bonded to the front side of the core layer, the top layer defining a front face which is receptive to solvent-based inks;
wherein a unit weight of the substrate is about 270 g/m² or less.

2. The graphics substrate of claim 1 wherein a unit weight of the substrate is about 203 g/m² or less.

3. The graphics substrate of claim 1 wherein the top layer is substantially opaque.

4. The graphics substrate of claim 1 wherein the core layer and the top layer are selected such that the substrate may be recycled without prior separation of the layers.

5. The graphics substrate of claim 1 wherein the core layer and the top layer both comprise polyolefins.

6. The graphics substrate of claim 1 wherein the core layer consists essentially of woven polypropylene.

7. The graphics substrate of claim 1 wherein the core layer consists essentially of woven polyethylene sheet.

8. The graphics substrate of claim 1 wherein the core layer consists essentially of non-woven polypropylene.

9. The graphics substrate of claim 6 wherein the top layer consists essentially of polypropylene.

10. The graphics substrate of claim 6 wherein the front face is defined by a print-receptive coating applied to the top layer.

11. The graphics substrate of claim 1 wherein a tying layer effective to bond the top layer and the core layer together is disposed therebetween.

12. The graphics substrate of claim 1 further comprising a backing layer bonded to the back side of the core layer.

13. The graphics substrate of claim 12 further comprising a tying layer effective to bond the backing layer and the core layer together disposed therebetween.

14. The graphics substrate of claim 1 wherein the core layer is black.

15. The graphics substrate of claim 12 wherein the backing layer is black.

16. A graphics substrate, comprising:
a core layer having opposed front and back sides; and
a polymeric top layer bonded to the front side of the core layer, the top layer defining a front face which is receptive to solvent-based inks;
wherein the top layer and the core layer are adapted to be recycled without first being separated.

17. The graphics substrate of claim 16 wherein the is substrate is substantially opaque.

18. The graphics substrate of claim 16 wherein the core layer and the top layer both comprise polyolefins.

19. The graphics substrate of claim 16 wherein the core layer consists essentially of woven polypropylene.

20. The graphics substrate of claim 16 wherein the core layer consists essentially of woven polyethylene.

21. The graphics substrate of claim 16 wherein the core layer consists essentially of non-woven polypropylene.

22. The graphics substrate of claim 19 wherein the top layer consists essentially of polypropylene.

23. The graphics substrate of claim 16 wherein the front face is defined by a print-receptive coating disposed on the top layer.

24. The graphics substrate of claim 16 wherein a tying layer effective to bond the top layer and the core layer together is disposed therebetween.

25. The graphics substrate of claim 16 further comprising a backing layer bonded to the back side of the core layer.

26. The graphics substrate of claim 25 further comprising a tying layer effective to bond the backing layer and the core layer together disposed therebetween.

27. A method of making a graphics substrate, comprising:
providing a core layer having opposed front and back sides; and
bonding a polymeric top layer to the front side of the core layer, the top layer defining a front face which is receptive to solvent-based inks;
wherein the top layer and the core layer are adapted to be recycled without first being separated.

28. The method of claim 27 wherein the top layer is bonded to the core layer by the steps of:
extruding a polymeric top layer onto the front side of the core layer in a fluid state; and
allowing the top layer to solidify.

29. The method of claim 27 wherein the top layer is bonded to the core layer by a lamination process comprising:
heating the top layer;
pressing the top layer onto the front side of the core layer; and
allowing the top layer to bond to the core layer.

30. The method of claim 27 wherein the top layer is bonded to the core layer by a lamination process comprising:
disposing a tying layer between the top layer and core layer;
pressing the top layer to the front side of the core layer; and
allowing the top layer to bond to the core layer.

31. The method of claim 27 wherein the core layer and the top layer are co-extruded in a fluid state and then allowed to solidify.

32. The method of claim 27 wherein the front face includes a coating receptive to solvent-based inks.

33. The method of claim 27 further comprising:
subjecting the front face to a treatment effective to increase its surface energy; and
applying a coating receptive to solvent-based inks to the front face.

34. The method of claim 32 wherein the coating comprises an acrylic material.

35. The method of claim 34 wherein the coating comprises calcium carbonate.

36. The method of claim 27 wherein a unit weight of the substrate is about 270 g/m² or less.

37. The method of claim 27 wherein a unit weight of the substrate is about 203 g/m² or less.

38. The method of claim 27 wherein the core layer and the top layer both comprise polyolefins.

39. The method of claim 27 wherein the core layer consists essentially of woven polymer sheet.

40. The method of claim 27 wherein the top layer consists essentially of polypropylene.

41. The method of claim 27 wherein a tying layer effective to bond the top layer and the core layer together is disposed therebetween prior to bonding of the core layer to the top layer.

42. The method of claim 27 further comprising bonding a backing layer to the back side of the core layer.

43. The method of claim 42 wherein a tying layer effective to bond the backing layer and the core layer together is disposed therebetween prior to bonding of the backing layer to the core layer.

44. A graphics display, comprising:
a support; and
a graphic substrate carried by the support, the substrate including:
a core layer having opposed front and back sides;
a polymeric top layer bonded to the front side of the core layer, the top layer defining an exposed front face which is receptive to solvent-based inks; and
graphics printed on the front face;
wherein the core layer and the top layer are selected such that the substrate may be recycled without prior separation of the layers.

45. The graphics display of claim 44 wherein the product is substantially opaque.

46. The graphics display of claim 44 wherein a unit weight of the substrate is about 270 g/m² or less.

47. The graphics display of claim 44 wherein a unit weight of the substrate is about 203 g/m² or less.

48. The graphics display of claim 44 wherein the core layer and the top layer both comprise polyolefins.

49. The graphics display of claim 44 wherein the core layer consists essentially of woven polypropylene.

50. The graphics display of claim 44 wherein the core layer consists essentially of woven polyethylene.

51. The graphics display of claim 44 wherein the core layer consists essentially of non-woven polypropylene.

52. The graphics display of claim 41 wherein the top layer consists essentially of polypropylene.

53. The graphics display of claim 44 wherein the front face is defined by a print-receptive coating applied to the top layer.

54. The graphics display of claim 44 wherein the support is a billboard.
